(19) United States
(12) Patent Application Publication
(10) Pub. No.: US 2025/0241226 A1
(43) Pub. Date: Jul. 31, 2025

(54) DEVICE FOR CONSTRUCTING A FURROW

(71) Applicant: Travis Lloyd CONKIN, Chilliwack (CA)

(72) Inventor: Travis Lloyd CONKIN, Chilliwack (CA)

(21) Appl. No.: 18/744,929

(22) Filed: Jun. 17, 2024

Related U.S. Application Data
(63) Continuation-in-part of application No. 18/428,378, filed on Jan. 31, 2024.

(51) Int. Cl. A01C 5/06; A01B 49/06; A01B 63/00

(52) U.S. Cl. CPC A01C 5/062; A01C 5/068; A01C 7/20

(57) ABSTRACT

A planter includes a furrow opener for constructing a furrow, a furrow closer of the planter to close the furrow, and a seeder of the planter positioned between the furrow opener and the furrow closer. A furrowing shoe of the furrow opener tapers to a leading end from a trailing end, which defines a trailing end, to form the furrow. A base of the furrow opener is tapered based on the furrowing shoe so as to be complementarily shod by the furrowing shoe. The base and the furrowing shoe are selectively peripherally interlockable so as to support the furrowing shoe vertically higher or lower, relative to the base, to define a furrow height when the furrowing shoe is received on the base. A resilient member of the furrow opener is positioned to urge the furrowing shoe and the base towards each other to inhibit peripheral disengagement.

### CROSS-REFERENCE TO RELATED APPLICATION

Any and all priority claims identified in the Application Data Sheet, or any correction thereto, are hereby incorporated by reference under 37 CFR 1.57.

This application is a continuing application of U.S. patent application Ser. No. 18/428,378 filed on 31 Jan. 2024, which application is incorporated by reference herein in its entirety, and is hereby expressly made a part of this specification.

### TECHNICAL FIELD

The disclosure relates generally to gardening devices, and more particularly to planters with devices for constructing furrows.

### BACKGROUND

This disclosure relates to planters suitable for furrowing and/or planting seed in a planting ground.

In farming and gardening it is typically desired that seeds be planted in a manner so as to achieve high productivity. To achieve this, seeds need to be planted at particular depths and need to be spaced apart from each other by particular distances. For example, iceberg lettuce may need to be spaced ten inches apart to achieve a desired growth. Some types of seeds tend to germinate at a lower rate than others. For such types of seeds it is sometimes desired to plant groups of multiple seeds together and in close proximity to each other as insurance against non-germinating seeds, e.g. groups of two iceberg lettuce seeds, spaced two inches apart from each other, may be planted ten inches apart from each other. During planting season, achieving tight control over parameters such as those described above while maintain a high tempo of planting is challenging.

In large-scale farming, seeds are commonly planted using large planting machines suitable for seeding multiple rows at a time. Plants planted by home gardeners and small farmers frequently show poorer performance because of lack of access to such automated planting machines; these machines tend to be complex, expensive, and often ill-suited for use on a small number of seed rows and/or along short rows. Efficacious planters (planting devices) generally require the ability to handle a variety of seed sizes, and seed spacings along the planting ground (inter-speed spacings).

Seeds are planted by first digging a hole or a furrow to a desired depth, then releasing one or more seeds, and then closing the hole or furrow. As mentioned above, furrows or holes need to be dug to a predetermined height. This height may depend on the type of seed that needs to be planted.

Furrow openers are devices used to dig furrows (or “open” furrows). It is important for furrow openers to have the requisite rigidity to allow digging through the soil. For example, if not sufficiently rigid, furrow openers may bend and lead to failure in opening furrows or to improperly formed furrows. In many cases, the connection or coupling between the furrow opener and a handle or the rest of the planter may be insufficiently rigid, despite the furrow opener itself being highly rigid, e.g. the furrow opener may be made of steel, to yield a sufficiently rigid furrow opener.

Furrow closers are devices used to close furrows. These are usually used in tandem with furrow openers to form and close a furrow or may be used on their own to close a pre-existing furrow. The furrow opener displaces a certain amount of soil from the ground to form the furrow. It is desired that the furrow closer replace that amount of soil back into the furrow in an appropriate manner. In practice, furrow closers may not push in all of the displaced soil back into the furrow or scrap away soil from adjacent to the furrow into the furrow. III-closed furrows can lead to poor seed germination characteristics and can be deleterious to plant growth.

### SUMMARY

In some aspects, there is described a device for constructing a furrow on planting ground. The device also includes a furrowing shoe for constructing the furrow, the furrowing shoe tapering to a leading end from a trailing end defining a furrow width; a base that is suitable for being drawn along the planting ground and that is tapered based on the furrowing shoe so as to be complementarily shod by the furrowing shoe between the leading and trailing ends, the base and the furrowing shoe being selectively peripherally interlockable at first or second furrowing positions of the furrowing shoe so as to support the furrowing shoe vertically high at the first furrowing position or vertically low at the second furrowing position to allow the trailing end to modulate a furrow height when the furrowing shoe is received on the base; and a resilient member that is positioned to urge the furrowing shoe and the base towards each other to inhibit peripheral disengagement of the furrowing shoe and the base from each other.

Implementations may include one or more of the following features. The device where the base and the furrowing shoe may include a plurality of projections extending between the base and the furrowing shoe, each of the plurality of projections being suitable to be received in at least one recess to modulate the furrow height and to facilitate interlocking of the base and the furrowing shoe. The furrowing shoe may include a plurality of projections extending from an inner surface of the furrowing shoe and being vertically spaced apart from each other, and the base may include a plurality of recesses extending along a periphery of the base and being vertically spaced apart from each other, the plurality of projections and the plurality of recesses configured to interlock with each other to position the furrowing shoe relative to the base to modulate the furrow height. The leading end forms an apex for pushing soil from opposite sides of the apex away from the furrowing shoe to construct the furrow, the plurality of projections extending from the inner surface of the furrowing shoe at the opposite sides, the plurality of recesses extending along the periphery of the base at the opposite sides. The resilient member is a torsional spring coupled to the furrowing shoe proximal to the trailing end of the furrowing shoe, relative to the leading end, so as to rotationally urge a paddle against the base to push the base and the leading end of the furrowing shoe towards each other to inhibit peripheral disengagement of the furrowing shoe and the base from each other, the furrowing shoe being releasable from the base via rotation of the paddle away from the base.

In some aspects, there is described a planter for planting seed in a planting ground. The planter also includes a furrow opener configured to construct a furrow in the planting ground as the planter is drawn along the planting ground, including a furrowing shoe that tapers to a leading end from a trailing end to form the furrow, the trailing end defining a furrow width, a base that is suitable for being drawn along the planting ground and that is tapered based on the furrowing shoe so as to be complementarily shod by the furrowing shoe between the leading and trailing ends, the base and the furrowing shoe being selectively peripherally interlockable at first or second furrowing positions of the furrowing shoe so as to support the furrowing shoe vertically higher, relative to the base, at the first furrowing position or vertically lower, relative to the base, at the second furrowing position to allow the trailing end to define a furrow height when the furrowing shoe is received on the base, and a resilient member that is positioned to urge the furrowing shoe and the base towards each other to inhibit peripheral disengagement of the furrowing shoe and the base from each other. The planter also includes a furrow closer to close the furrow; and a seeder positioned between the furrow opener and the furrow closer to release the seed into the furrow.

Implementations may include one or more of the following features. The planter where the base and the furrowing shoe may include a plurality of projections extending between the base and the furrowing shoe, each of the plurality of projections being suitable to be received in at least one recess to modulate the furrow height and to facilitate interlocking of the base and the furrowing shoe. The furrowing shoe may include a plurality of projections extending from an inner surface of the furrowing shoe and being vertically spaced apart from each other, and the base may include a plurality of recesses extending along a periphery of the base and being vertically spaced apart from each other, the plurality of projections and the plurality of recesses configured to interlock with each other to position the furrowing shoe relative to the base to modulate the furrow height. The leading end forms an apex for pushing soil from opposite sides of the apex away from the furrowing shoe to construct the furrow, the plurality of projections extending from the inner surface of the furrowing shoe at the opposite sides, the plurality of recesses extending along the periphery of the base at the opposite sides. The resilient member is a torsional spring coupled to the furrowing shoe proximal to the trailing end of the furrowing shoe, relative to the leading end, so as to rotationally urge a paddle against the base to push the base towards the leading end of the furrowing shoe to inhibit peripheral disengagement of the furrowing shoe and the base from each other, the furrowing shoe being releasable from the base via rotation of the paddle away from the base. The furrow closer includes: a central wall extending obliquely towards the planting ground from a seeding end to a tamping end proximal to the planting ground relative to the seeding end, the central wall laterally tapering to the furrow width from the seeding end to the tamping end, first and second sidewalls positioned at laterally opposite ends of the central wall between the seeding and tamping ends and extending at least partially lateral to the central wall towards the planting ground so as to push soil towards the furrow underneath the central wall to allow the central wall to urge the soil into the furrow to close the furrow, and a tamper positioned at the tamping end for tamping down on the planting ground; and The central wall extends obliquely towards the planting ground at between 15 and 20 degrees relative to the planting ground, and the central wall, the first sidewall, and the second sidewall are planar walls that are angled relative to each other. The tamper is substantially rectangular and extends laterally at least the furrow width. The planter may include: a first wheel positioned at a first lateral end of the planter; and a second wheel positioned at a second lateral end of the planter, the central wall disposed behind and laterally in-between the first wheel and the second wheel. The furrow closer is positioned higher than a lower end of the furrow opener.

In some aspects, there is described a method of assembling a device for constructing a furrow on planting ground. The method also includes shoeing a furrowing shoe over a base between trailing and leading ends of the furrowing shoe; and interlocking the furrowing shoe with a periphery of the base to support the furrowing shoe in place while the base is drawn along planting ground to draw the furrowing shoe through the planting ground to construct the furrow.

Implementations may include one or more of the following features. The method where the base and the furrowing shoe may include a plurality of projections extending between the base and the furrowing shoe, each of the plurality of projections being suitable to be received in at least one recess to modulate a furrow height and to facilitate interlocking of the base and the furrowing shoe. The furrowing shoe may include a plurality of projections extending from an inner surface of the furrowing shoe and being vertically spaced apart from each other, and the base may include a plurality of recesses extending along a periphery of the base and being vertically spaced apart from each other, the plurality of projections and the plurality of recesses configured to interlock with each other to position the furrowing shoe relative to the base to modulate a furrow height. The leading end forms an apex for pushing soil from opposite sides of the apex away from the furrowing shoe to construct the furrow, the plurality of projections extending from the inner surface of the furrowing shoe at the opposite sides, the plurality of recesses extending along the periphery of the base at the opposite sides. The method may include: urging the furrowing shoe and the base towards each other using a resilient member to inhibit peripheral disengagement of the furrowing shoe and the base from each other. The resilient member is a torsional spring coupled to the furrowing shoe proximal to the trailing end of the furrowing shoe, relative to the leading end, so as to rotationally urge a paddle against the base to push the base and the leading end of the furrowing shoe towards each other to inhibit peripheral disengagement of the furrowing shoe and the base from each other, the furrowing shoe being releasable from the base via rotation of the paddle away from the base.

Embodiments can include combinations of the above features.

Further details of these and other aspects of the subject matter of this application will be apparent from the detailed description included below and the drawings.

### DESCRIPTION OF THE DRAWINGS

Reference is now made to the accompanying drawings, in which:

FIG. 1A is a front top perspective view of a planter, in accordance with an embodiment;

FIG. 1B is a rear elevation view of the planter, in accordance with an embodiment;

FIG. 1C is bottom rear isometric view of the planter, in accordance with an embodiment;

FIG. 1D is a side elevation view of the planter, in accordance with an embodiment;

FIG. 2 is an exploded view of the planter, in accordance with an embodiment;

FIG. 3 is a cross-sectional view of the planter along a plane defined by the line 3-3 in FIG. 1D, in accordance with an embodiment;

FIG. 4A is a front perspective view of a seed receiver, in accordance with an embodiment;

FIG. 4B is a rear perspective view of the seed receiver, in accordance with an embodiment;

FIG. 4C is a cross-sectional view of the seed receiver along a plane defined by the line 4C-4C in FIG. 4A, in accordance with an embodiment;

FIG. 5A is a cross-sectional view of the planter along a plane defined by the line 5-5 in FIG. 1B, wherein the seeder is in a first configuration, in accordance with an embodiment;

FIG. 5B is a cross-sectional view of the planter along a plane defined by the line 5-5 in FIG. 1B, wherein the seeder is in a second configuration, in accordance with an embodiment;

FIG. 6A is a bottom perspective view of a furrowing shoe, in accordance with an embodiment;

FIG. 6B is a bottom plan view of the furrowing shoe, in accordance with an embodiment;

FIG. 6C is a cross-sectional view of the furrowing shoe along a plane 6C-6C in FIG. 6B, in accordance with an embodiment;

FIG. 7A is a cross-sectional view of the planter along a plane defined by the line 5-5 in FIG. 1B, wherein the furrow opener is in a first configuration, in accordance with an embodiment;

FIG. 7B is a cross-sectional view of the planter along a plane defined by the line 5-5 in FIG. 1B, wherein the furrow opener is in a second configuration, in accordance with an embodiment;

FIG. 8 is an enlarged view of a portion of the furrow opener, in accordance with an embodiment;

FIG. 9A is a top plan view of the furrow closer, in accordance with an embodiment.

FIG. 9B is a front elevation view of the furrow closer, in accordance with an embodiment;

FIG. 9C is a side elevation view of the furrow closer, in accordance with an embodiment;

FIG. 10 is a side elevation view of a handle, in accordance with an embodiment;

FIG. 11 is an exemplary flowchart of a method of configuring a planter to selectively define an inter-seed spacing on a planting ground;

FIG. 12 is an exemplary flowchart of a method of assembling a device for constructing a furrow on planting ground; and

FIG. 13 is an exemplary flowchart of a method of closing a furrow formed in a planting ground.

### DETAILED DESCRIPTION

The following disclosure relates to planters used for gardening and small-scale farming. In some embodiments, the devices and methods disclosed herein can facilitate formation and closing of furrows in a planting ground, and planting of seeds therein. For example, selective planting of seeds of a certain type may be achieved, an inter-seed spacing on the planting ground may be selectively varied, the height of the furrow may be varied, and improved closing of the furrow may be achieved.

Advantageously, in some cases, the cost to manufacture and operate the parts of embodiments disclosed may be considerably less than other systems, particularly for system providing a variety seed spacing and accommodating a variety of seed sizes. Furthermore, in some embodiments, greater flexibility may be achieved. For example, in some embodiments, a variety of seed spacings and accommodation of a variety of seed sizes may be achieved without requiring changing out a complex set of complimentary gears, disassembly, and/or replacement of difficult to remove components.

Aspects of various embodiments are now described in relation to the figures.

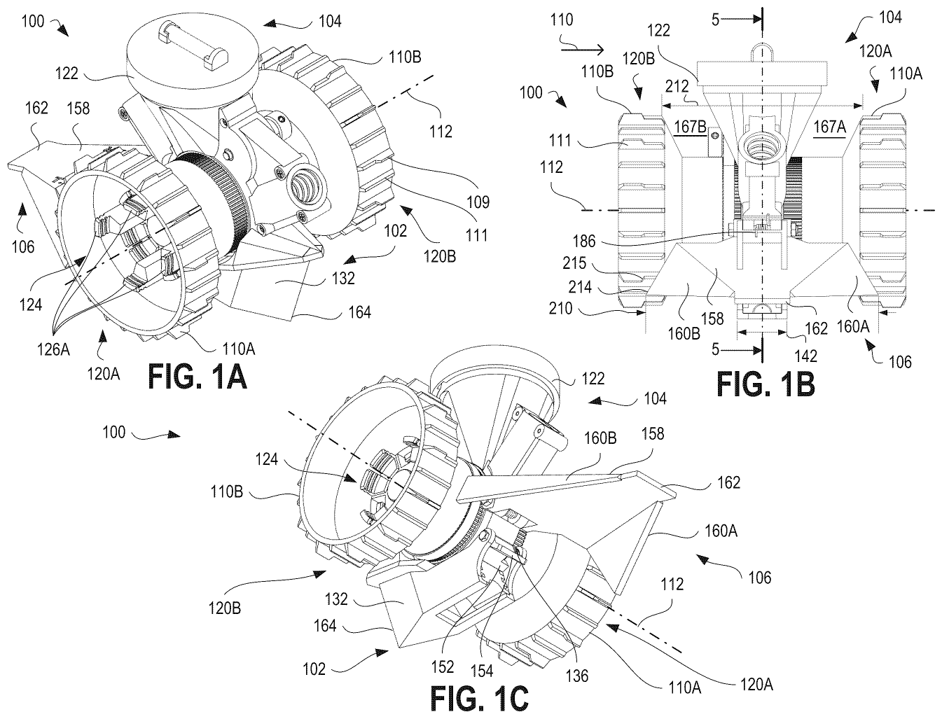

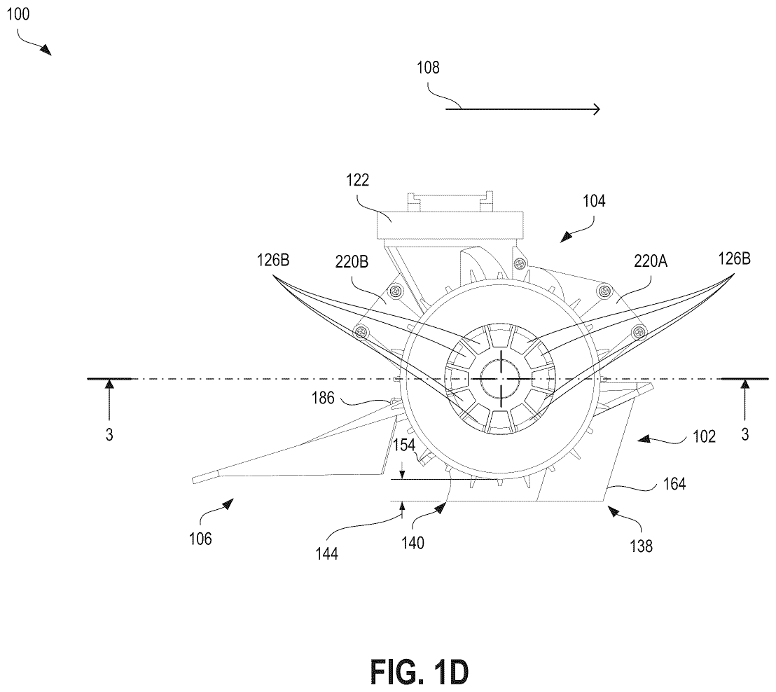

FIG. 1A is a front top perspective view of a planter 100, in accordance with an embodiment.

FIG. 1B is a rear elevation view of the planter 100.

FIG. 1C is bottom rear isometric view of the planter 100.

FIG. 1D is a side elevation view of the planter 100.

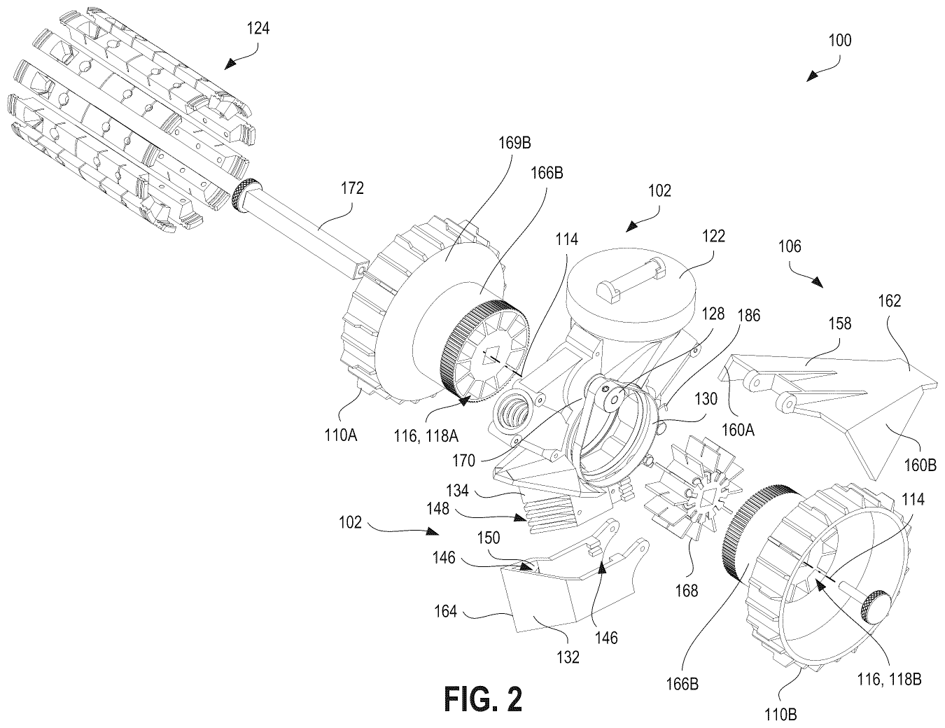

FIG. 2 is an exploded view of the planter 100.

The planter 100 may generally include a furrow opener 102, a seeder 104, and a furrow closer 106.

The furrow opener 102 is configured to construct a furrow in a planting ground as the planter is drawn along the planting ground in a longitudinal direction 108.

The seeder 104 is configured to place seed (a single seed, a group of seeds, or a volume of seeds) into the furrow as the planter 100 is drawn longitudinally along the planting ground. The furrow closer 106 is configured to close the furrow after the seeder 104 has placed one or more seeds into the planting ground.

The planter 100 is configured for a furrow that extends in the longitudinal direction 108 and defines a width lateral to the longitudinal direction 108, as indicated by the lateral direction 110 shown in FIG. 1B. It is understood that the lateral direction 110 shown in FIG. 1B may be reflected without loss of generality.

It is understood that, in various embodiments, the planter 100 may include the seeder 104 only, or the seeder 104 and one or both of the furrow opener 102 and the furrow closer 106. For example, in various embodiments, the furrow opener 102 and/or the furrow closer 106 may form one or more separate devices.

As shown in FIGS. 1A-1D and FIG. 2, the planter 100 includes wheels 110A, 110B. The wheels 110A, 110B define a central axis 112. The wheels 110A, 110B are rotatable about the central axis to draw the planter 100 along the planting ground. In various embodiments, the planter 100 may have only one wheel or may have more than two wheels. In various embodiments, the wheels 110A, 110B may be identical to each other, which may be particularly advantageous to improve manufacturability.

In various embodiments, the wheels may comprise projections extending radially outwardly therefrom. Such projections may include uniform projections 109 that are extend a uniform radial distance away from the corresponding one of the wheels 110A, 110B. Such projections may include projections 111 that are non-uniform or tapered in that they extend a non-uniform distance away from the corresponding one of the wheels 110A, 110B. For example, the projections 111 may include an axially outer portion that extends radially outwardly more than an axially inner portion. Advantageously, this may facilitate mitigating spreading of soil away from the furrow. For example, closing of the furrow may be improved. The projections 109, 111 may generally facilitate gripping of the planter 100 on to the planting ground. In the embodiments shown in FIGS. 1A-1D, the projections 109, 111 extend radially outwardly from the outer edges of the wheels 110A, 110B. The projections 109 may be used as row markers to mark the planting ground to facilitate spacing of plants in small planting areas. For example, a planting row may be marked while a furrow is being dug.

In various embodiments, the uniform projections 109 and the projections 111 may interspersed around each of the wheels 110A, 110B. For example, the uniform projections 109 and the projections 111 may be interleaved around each of the wheels 110A, 110B. For example, the projections 109 may be equally spaced apart around each of the wheels 110A, 110B. For example, the projections 111 may be equally spaced apart around each of the wheels 110A, 110B.

The planter 100 may include a plurality of slots 116 angularly spaced apart from each other around a slot axis 114. As shown in FIG. 2, the plurality of slots 116 may include slot portions 118A, 118B formed in respective wheels 110A, 110B. The wheels 110A, 110B may be positioned at opposite lateral ends 120A, 120B of the planter 100.

The plurality of slots 116 may be coupled to the wheels 110A, 110B so as to rotate around the slot axis 114 as the wheels 110A, 110B rotate about the central axis 112.

The slot axis 114 may be parallel to the central axis 112. In various embodiments, the slot axis 114 and the central axis 112 may be non-coincident or spaced apart from each other. In some embodiments, the slot axis 114 may be non-parallel to the central axis 112. For example, it is conceived that, in some embodiments, the wheels 110A, 110B may be mechanically coupled to the plurality of slots 116 to allow the plurality of slots to rotate around a slot axis 114 that is angled relative to the central axis 112 when the wheels 110A, 110B rotate. Nevertheless, it is found to be particularly advantageous for the slot axis 114 and the central axis 112 to be parallel and coincident.

In FIG. 2, the plurality of slots 116 are formed around hubs of the wheels 110A, 110B. The plurality of slots 116 so formed may be disposed inside radially outer ends of the wheels 110A, 110B. Advantageously, in some embodiments, the plurality of slots 116 may be formed by slot portions 118A, 118B that are in unitary construction with the respective wheels 110A, 110B such that rotation of the wheels 110A, 110B (about the central axis 112) is associated with rotation of the plurality of slots 116 (about the slot axis 114 and the central axis 112). For example, greater rigidity and manufacturability may thereby be achieved. It is understood that, in various embodiments, the slot portions 118A, 118B may be formed in a single wheel only or may be formed separately from the wheel.

The wheels 110A, 110B and the corresponding slot portions 118A, 118B may be defined by respective rotors 166A, 166B. Advantageously, in some embodiments, the plurality of slots 116 may be formed by coupling the two rotors 166A, 166B and an intermediate rotor 168 to each other. The intermediate rotor 168 may comprise a hub with slats extending radially outwardly therefrom. The intermediate rotor 168 may be received in a housing 170 of the planter 100. The slats may engage or abut against an inner portion of the housing to form portions of the plurality of slots 116. Such portions may be contiguous with the slot portions 118A, 118B to form the plurality of slots 116.

The wheels 110A, 110B and their respective rotors 166A, 166B may define therebetween spaces 167A, 167B shown in FIG. 1B. The spaces 167A, 167B may extend circumferentially around the rotors 166A, 166B, i.e. about the central axis 112. The spaces 167A, 167B may extend axially between a central body of the seeder 104 and respective wheels 110A, 110B. The spaces 167A, 167B may be suitable to receive soil that is displaced out of the planting ground as a furrow is formed in the planting ground.

The rotors 166A, 166B and the intermediate rotor 168 may be coupled to each other via a coupling shaft 172. The coupling shaft 172 may be configured for passing through apertures formed in the rotors 166A, 166B and the intermediate rotor 168. One or more components, such as threaded thumb screws or retaining pins, may be received into end(s) of the coupling shaft 172 to retain the coupling shaft 172 in position so as to support the rotors 166A, 166B and the intermediate rotor 168 fixed in position relative to each other. In various embodiments, the coupling shaft 172 may have a polygonal, e.g. square, outer circumference to mitigate slippage of the coupling shaft 172 relative to the rotors 166A, 166B and the intermediate rotor 168.

The assembly of the planter 100 depicted in FIG. 2 may be particularly advantageous. For example, the planter 100 may be readily disassembled and greater manufacturability may be achieved.

The seeder 104 may further comprise a plurality of seed receivers 124. Each of the plurality of seed receivers 124 may be received into a corresponding slot of the plurality of slots 116 so that the plurality of seed receivers 124 rotate around the slot axis 114 as the plurality of slots 116 rotate around the slot axis 114.

Each slot of the plurality of slots 116 and each seed receiver of the plurality seed receivers 124 may extend between the wheels 110A, 110B. Each slot portion 118A, 118B may be adapted for removable insertion of a corresponding seed receiver of the plurality of seed receivers 124. In various embodiments, the wheels 110A, 110B may be configured to permit lateral passage of the plurality of seed receivers 124, via the housing 170, through the wheel 110B after insertion through the wheel 110A (and vice versa).

Each seed receiver of the plurality of seed receivers 124 may be selectively positionable within a corresponding slot of the plurality of slots 116. By such positioning, the spacing between individual (or individual groups of) seeds planted in the planting ground (inter-seed spacing) may be varied and a particular sequential arrangement of seeds may be achieved. In particular, the positioning of a seed receiver within its respective slot determines whether that seed receiver discharges seed into the planting ground for each revolution of the wheels 110A, 110B. Since each revolution of the wheels 110A, 110B defines a particular distance of travel on the planting ground, the inter-seed spacing may be substantially fixed by positioning of the plurality of seed receivers 124 within their respective slots.

In FIGS. 1A-1D and FIG. 2, the planter 100 has only twelve seed receivers. This may be a particularly advantageous number of seed receivers, since then the planter 100 may readily achieve an inter-speed spacing corresponding to all, half, one-third, one-fourth, one-sixth, or one-twelfth of the distance of travel per revolution of the wheels 110A, 110B, corresponding to respective one, two, three, four, six, or twelve individual (or individual groups of seeds) per the distance of travel per revolution of the wheels 110A, 110B. For example, if the diameter of the wheels 110A, 110B is set so that the distance of travel per revolution corresponds to a standard unit of measure, then inter-speed spacings corresponding to fractions of this standard unit of measure may be readily achieved. For example, in some embodiments, the wheels 110A, 110B may be interchangeable to allow greater inter-seed spacings, depending on the type of seed and/or plant.

Nevertheless, it is understood that in some embodiments, the planter 100 may be configured with a lesser or greater number of slots. For example, in various embodiments, the plurality of slots 116 may include only two, three, four, five, six, seven, eight, nine, ten, eleven, thirteen, fourteen, fifteen, sixteen or more slots.

For example, in FIGS. 1A-1D and FIG. 2, the planter 100 is shown in a configuration wherein the plurality of seed receivers 124 include a first seed receiver set 126A and a second seed receiver set 126B. Seed receivers defining the first seed receiver set 126A may be positioned at a first position within their respective slots and seed receivers defining the second seed receiver set 126B may be positioned at a second position with their respective slots, as illustrated in FIGS. 1A-1D, and FIG. 2. In some configurations, each of the plurality of seed receivers 124 may be positioned at the same position within their respective slots. In some configurations, the plurality of seed receivers 124 may define three, four, five, or more (disjoint) sets of seed receivers. As referred to herein, a seed receiver set includes a set having only a single seed receiver.

As shown in FIGS. 1A-1D and FIG. 2, the planter 100 may include a hopper 122 for holding seed. In some embodiments, the hopper 122 may form a vertically upper end of the planter 100 to advantageously generate a gravity-induced steady feed (or stream) of seed to supply to the plurality of seed receivers 124. In some embodiments, seed may be fed to the plurality of seed receivers 124 without a hopper 122. For example, seed may be fed to the plurality of seed receivers 124 via a seed supply tube.

In various embodiments, one or both of the wheels 110A, 110B may be coupled to a rejection wheel 128 such that rotation of the wheels 110A, 110B causes rotation of the rejection wheel 128. For example, the rejection wheel 128 may be coupled to the wheel 110B via a drive belt 130. The drive belt 130 may be frictionally coupled to the wheel 110B and the rejection wheel 128 by pressing against the wheel 110B and the rejection wheel 128.

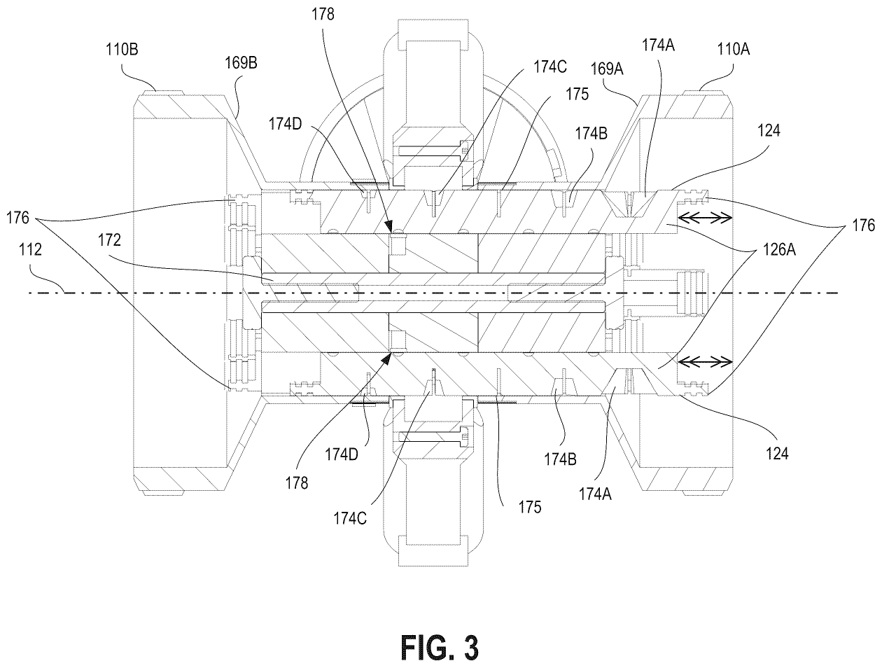

Further details of the seeder 104 and its operation will be described later in reference to FIGS. 3, 4A-4C, 5A-5B.

As mentioned previously, the furrow opener 102 is a device for constructing a furrow on planting ground. The furrow opener comprises a furrowing shoe 132, a base 134, and a resilient member 136. The furrowing shoe 132 is supported by the base 134 via the resilient member 136 such that drawing of the base 134 along the planting ground draws the furrowing shoe 132 along the planting ground for furrowing.

The furrowing shoe 132 pushes soil to construct the furrow as it is drawn along the planting ground. The furrowing shoe 132 tapers to a leading end 138 from a trailing end 140 that defines a furrow width 142 and a furrow height 144.

The furrow height 144 (or furrow depth) is shown notionally in FIG. 1D. The furrow opener 102 is configured such that the furrow extends from an outer edge of the wheels 110A, 110B to the bottom of the furrowing shoe 132. The furrow height may also be defined relative to the furrow closer 106 as will be described later.

The base 134 is tapered based on the furrowing shoe 132 so as to be complementarily shod by the furrowing shoe 132 between the leading end 138 and the trailing end 140. In various embodiments, the leading end 138 may form an apex 164 for pushing soil from opposite sides of the apex 164 away from the furrowing shoe to construct the furrow. For example, in embodiments including that shown in FIGS. 1A-1D, two planar walls forming therebetween an angle less than 180° or an acute angle (on a side facing to the planter 100) may meet at the leading end 138 to form an apex 164, such apex 164 being substantially sharp or flattened. These two planar walls may then respectively define the two opposite sides of the apex 164 (and the furrowing shoe 132), the planes pushing soil away from the planter 100 at least partially lateral to the longitudinal direction 108.

The base 134 and the furrowing shoe 132 are selectively peripherally interlockable at first or second furrowing positions of the furrowing shoe 132. Once interlocked with each other, drawing the base 134 along the planting ground draws the furrowing shoe 132 along the same. Such drawing of the furrowing shoe 132 along the planting ground causes the furrowing shoe 132 to dig a furrow, with the furrow height 144 defined by the trailing end 140, through the planting ground by pushing soil away from the furrowing shoe 132. Advantageously, in some embodiments, peripheral interlocking may improve rigidity and improve manufacturability.

In various embodiments, the base 134 and the furrowing shoe 132 may comprise a plurality of projections 146 extending therebetween. The plurality of projections 146 may be complementary to a plurality of recesses 148. Each of the plurality of projections 146 may be suitable to be received in at least one recess of the plurality of recesses 148 to modulate the furrow height 144 and to facilitate interlocking of the base 134 and the furrowing shoe 132.

The plurality of projections 146 and the plurality of recesses 148 may be configured to modulate a furrow height 144 by selectively interlocking with each other to (vertically) position the furrowing shoe 132 relative to the base 134. In other words, vertical positioning of the furrowing shoe 132 may at least partially define the furrow height 144. For example, base 134 and the furrowing shoe 132 may interlock at a first furrowing position or a second furrowing position. In the first furrowing position, the interlocking arrangement may support the furrowing shoe 132 vertically high (or higher, relative to the second furrowing position) and in the second furrowing position, the interlocking arrangement may support the furrowing shoe 132 vertically lower (or lower, relative to the first furrowing position) to allow the formation of a furrow with variable height. Thus, the furrow height 144 may be smaller in the first furrowing position than in the second furrowing position, i.e. the furrow formed with the furrowing shoe 132 in the first furrowing position may be shallower than the furrow formed with the furrowing shoe 132 in the second furrowing position.

In various embodiments, the plurality of projections 146 may extend outwardly from an inner surface 150 of the furrowing shoe 132, at the opposite sides of the apex 164. The plurality of projections 146 may be vertically spaced apart from each other. In various embodiments, the plurality of projections 146 may be parallel to each other.

In various embodiments, the plurality of recesses 148 may extend along a periphery of the base 134 at the opposite sides at the apex 164. The plurality of recesses 148 may be vertically spaced apart from each other. In various embodiments, the plurality of recesses 148 may be parallel to each other.

It is understood that in some embodiments, the plurality of projections 146 may extend outwardly from an outer surface of the base 134 and/or the plurality of recesses 148 may be formed in the inner surface 150 of the furrowing shoe 132. In some embodiments, some projections may extend from the base 134 and some projections may extend from the furrowing shoe 132. In some embodiments, some recesses may be formed in the base 134 and some recesses may be formed in the furrowing shoe 132.

In some embodiments, it may be particularly advantageous to have the plurality of projections 146 extending from the furrowing shoe 132 and the plurality of recesses 148 being formed in the base 134 since the thickness of the base 134 may generally be larger than the thickness of the furrowing shoe 132. For example, the plurality of recesses 148 may be made deeper in the base 134 than in the furrowing shoe 132. Thus, greater interlocking of the base 134 and the furrowing shoe 132 may be achieved. Greater rigidity and assembly integrity may thereby be achieved.

The resilient member 136 is positioned to urge the furrowing shoe 132 and the base 134 towards each other to inhibit peripheral disengagement of the furrowing shoe 132 and the base 134 from each other.

In various embodiments, the resilient member 136 may be a spring. The spring may be a torsional spring. In the embodiment shown in FIGS. 1A-1D, the resilient member 136 is a torsional spring coupled to the furrowing shoe 132.

In various embodiments, the resilient member 136 may be proximal to the trailing end 140 of the furrowing shoe 132, relative to the leading end 138. Advantageously, the resilient member 136 may thereby be shielded from accumulating and moving soil proximal to the leading end 138. For example, jamming of a coupling connection between the resilient member 136 and the furrowing shoe 132 and/or the base 134 may thereby be mitigated.

In FIGS. 1A-1D, the resilient member 136 is shown positioned proximal to the trailing end 140 of the furrowing shoe 132 so as to rotationally urge a paddle 152 against the base 134 to push the base 134 and the leading end 138 of the furrowing shoe 132 towards each other to inhibit peripheral disengagement of the furrowing shoe 132 and the base 134 from each other.

The furrowing shoe 132 may be releasable from the base 134 via rotation of the paddle 152 away from the base 134. In various embodiments, the paddle 152 may be rotated away from the base 134 by rotation of a tab 154 extending outwardly so as to facilitate grasping by a user. In some embodiments, the paddle 152 and the tab 154 are in unitary construction. The paddle 152 and the tab 154 may extend outwardly in opposite direction from a cylindrical slot. This cylindrical slot may be suitable to receive a pin that then passes through apertures formed in the furrowing shoe 132, and the base 134 so as to form a pin joint between the paddle 152, the furrowing shoe 132, and the base 134.

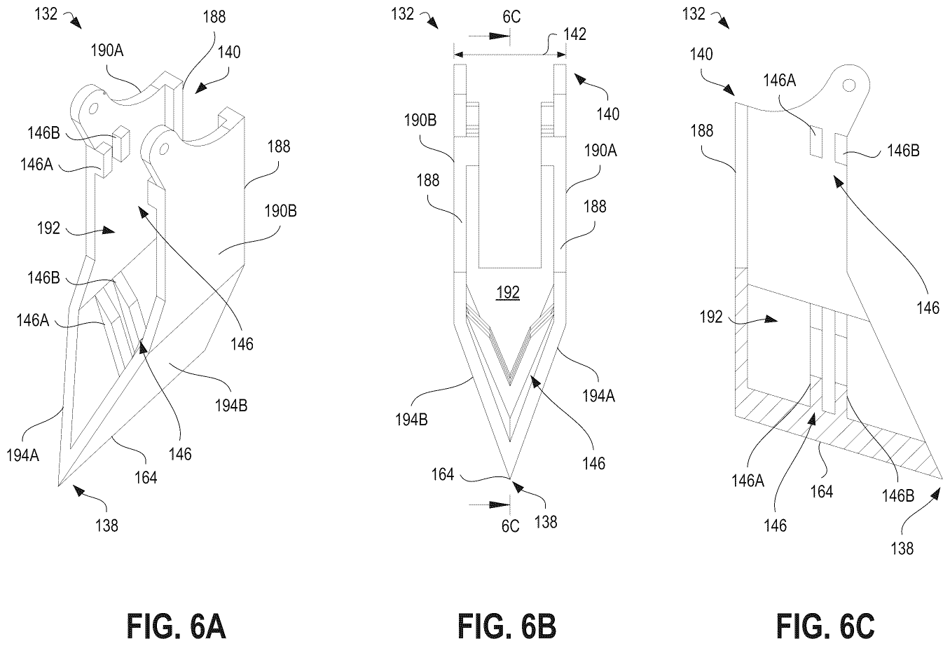

The furrow closer 106 includes a central wall 158, first and second sidewalls 160A, 160B, and a tamper 162, which components may generally be integrally coupled to each other and/or in unitary construction with each other. Further details of the furrow closer 106 will be described later in reference to FIGS. 6A-6C. A resilient member (torsion spring 186) that serves to couple the central wall 158, the sidewalls 160A, 160B, and the tamper 162 to the seeder 104 and/or the furrow opener 102. The resilient member may serve to push the central wall 158, the sidewalls 160A, 160B, and the tamper 162 towards the planting ground to facilitate closing of furrows.

FIG. 3 is a cross-sectional view of the planter 100 along a plane defined by the line 3-3 in FIG. 1D.

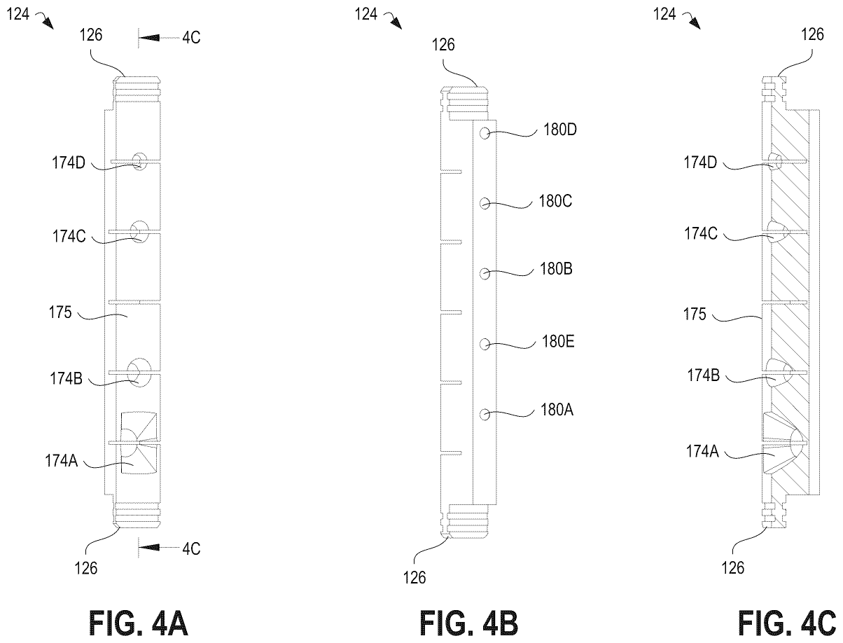

FIG. 4A is a front perspective view of a seed receiver, in accordance with an embodiment.

FIG. 4B is a rear perspective view of the seed receiver, in accordance with an embodiment.

FIG. 4C is a cross-sectional view of the seed receiver along a plane defined by the line 4C-4C in FIG. 4A.

In FIG. 3 and FIGS. 4A-4C, each seed receiver 124 defines a plurality of receptacles 174A, 174B, 174C, 174D. Each of the receptacles 174A, 174B, 174C may be configured to receive a single (type of) seed or a predetermined group (of types) of seeds. In the embodiment of FIG. 3 and FIGS. 4A-4C, the receptacle 174A may be suitable or dimensioned, e.g. sized or shaped, to receive a larger seed than may be receivable by each of the receptacles 174B, 174C, 174D, the receptacle 174B may be suitable to receive a larger seed than may be receivable by each of the receptacles 174C, 174D, and the receptacle 174C may be suitable to receive a larger seed than may be receivable by the receptacle 174D. Similarly, the receptacle 174D may be suitable or dimensioned, e.g. sized or shaped, to obstruct a seed that is suitable to be received by at least one of the receptacles 174A, 174B, 174C, the receptacle 174C may be suitable or dimensioned, e.g. sized or shaped, to obstruct a seed that is suitable to be received by at least one of the receptacles 174A, 174B, and the receptacle 174B may be suitable or dimensioned, e.g. sized or shaped, to obstruct a seed that is suitable to be received by the receptacle 174A.

As will be further illustrated below, the receptacles 174A, 174B, 174C, 174D may be suitable to hold particular seeds to carry them to the planting ground.

In various embodiments, one or more of each of the receptacles 174A, 174B, 174C, 174D is a groove suitable for receiving (no more than or at least) a single seed. For example, the groove may define sidewall(s) that taper from an opening of the groove to a bottom of the groove so as to facilitate reception of seed within the groove, e.g. by a funneling action. The bottom of the groove may be substantially flat. In various embodiments, the groove may be circumferentially circular. The opening of the groove may be circular. The sidewalls of may extend circularly around a cavity defined by the groove.

Each of the plurality of seed receivers 124 may further define an obstructing portion. The obstructing portion is void of receptacles suitable to receive seeds that are supplied to the planter 100, e.g. via the hopper 122.

Each of the plurality of seed receivers 124 may define a corresponding ledge 176 extending outwardly so as to facilitate grasping of the seed receivers 124. The ledge 176 may be used to move and reposition the seed receivers 124. Notional motion of the seed receivers 124 is indicated by double-headed double-chevron arrows in FIG. 3. Each of the seed receivers 124 may be movable parallel to the slot axis 114 and/or the central axis 112 to selectively cause repositioning of the receptacles 174A, 174B, 174C, 174D, and the obstructing portion 175, relative to the wheels 110A, 110B and/or the hopper 122.

The planter 100 may further include a plurality of detents 178. Each of the plurality of detents 178 may be configured to hold a corresponding one of the seed receivers 124 substantially fixed in place after positioning thereof relative to the wheels 110A, 110B and/or the hopper 122.

In the embodiment shown in FIG. 3, and FIGS. 4A-4C, the plurality of detents 178 may be a plurality of ball detents. Each of the ball detents may comprise a spring-loaded sphere that is receivable in of the apertures 180A, 180B, 180C, 180D, 180E. When the spring-loaded sphere is received in the apertures 180A-180D, the seed receiver 124 is held fixed so that the respective receptacles 174A-174D are held in position to receive seed. When the spring-loaded sphere is received in the aperture 180E, the seed receiver 124 is held fixed so that the obstructing portion 175 is held in position to obstruct seed.

In various embodiments, a narrow (linear) groove or slot runs through the receptacles, as shown, for receiving a wire that may be fixed to the seeder body directly above the seed outlet chute. This wire may function to reject stubborn, stuck seeds from the receptacle so they always drop with consistency, and do not reside in the receptacle for a complete rotation which would otherwise create jamming in the wheels and/or inconsistent seed spacing.

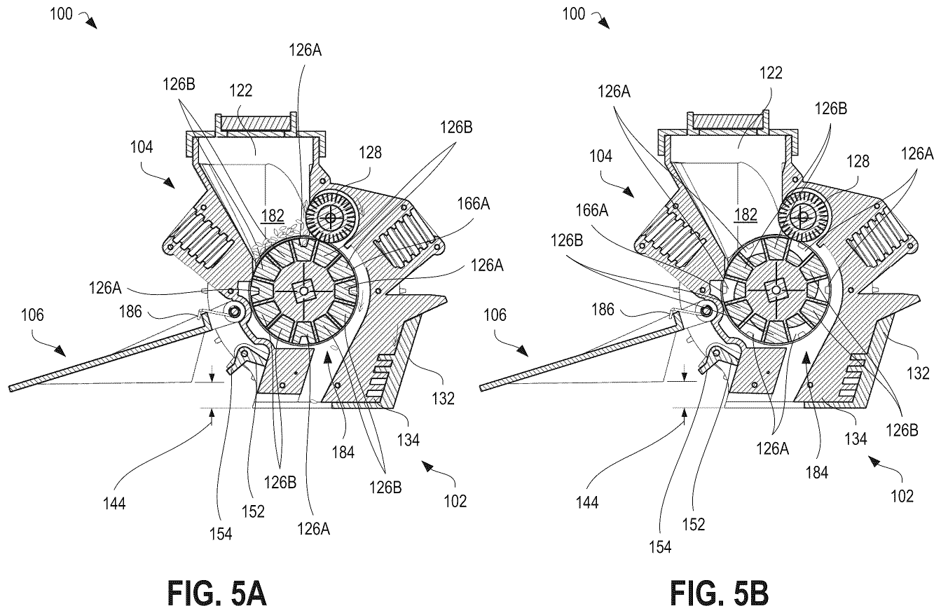

FIG. 5A is a cross-sectional view of the planter 100 along a plane defined by the line 5-5 in FIG. 1B, wherein the seeder 104 is in a first configuration.

FIG. 5B is a cross-sectional view of the planter 100 along a plane defined by the line 5-5 in FIG. 1B, wherein the seeder 104 is in a second configuration.

Movement of seed through the planter 100 is illustrated in FIG. 5A, along with double-chevron arrows indicating the rotational motion of the rejection wheel and the rotor 166A.

As shown in FIGS. 5A-5B, the planter 100 may define a seed inlet 182 suitable for receiving seed and a seed outlet 184 suitable to discharge the seed from the planter 100 towards the planting ground for planting.

In various embodiments, the seed inlet 182 may be connected to a seed hopper 122 disposed above the seed inlet 182 and the seed outlet 184. In some embodiments, the seed inlet 182 may be fed seed from a seed reservoir without a seed hopper 122. The seed inlet 182 may be disposed above the seed outlet 184.

As the wheels 110A, 110B (and rotors 166A, 166B) rotate, the plurality of seed receivers 124 rotate around the slot axis 114 between the seed inlet 182 and the seed outlet 184. In some embodiments, the central axis 112 and the slot axis 114 are coincident. In such embodiments, the plurality of seed receivers 124 rotate around the central axis 112.

As the seed receivers 124 rotate around the slot axis 114, they alternatively open to the seed inlet 182 and the seed outlet 184. Each seed receiver 124 may be selectively positionable within its corresponding slot of the plurality of slots 116 to selectively cause, as the seed receiver 124 rotates around the slot axis 114, either one of the receptacles 174A, 174B, 174C, 174D or the obstructing portion 175 of the seed receiver 124 to open to the seed inlet 182 and the seed outlet 184 as the wheels 110A, 110B rotate around the central axis 112. For example, selective carriage or prevention of carriage (by selective obstruction) of seed may thereby be achieved. In various embodiments, the positioning of the plurality of seed receivers 124 may be achieved by movement of the plurality of seed receivers 124 parallel to the slot axis 114.

When a seed receiver 124 is positioned so that one of its receptacles 174A, 174B, 174C, 174D opens to the seed inlet 182, and the seed inlet 182 receives seed suitable to be received by that one of the receptacles 174A, 174B, 174C, 174D, the seed is received into the receptacle as the seed receiver 124 opens to the seed inlet 182. When so received the receptacle allows carriage of the seed from the seed inlet 182 to the seed outlet 184 as the plurality of slots 116 rotate around the slot axis 114.

When a seed receiver 124 is positioned so that the obstructing portion 175 opens to the seed inlet 182, the receptacles 174A, 174B, 174C, 174D of that seed receiver 124 are obstructed to prevent carriage of the seed from the seed inlet 182 to the seed outlet 184. Such selective obstruction may also be achieved by positioning the seed receiver 124 such that the receptacle of receptacles 174A, 174B, 174C, 174D that opens to the seed inlet is dimensioned to obstruct seed in the seed inlet 182 from being received in that receptacle to thereby block carriage of the seed from the seed inlet 182 to the seed outlet 184. For example, such a receptacle may be smaller than the seed. As such, one or more of the receptacles 174A, 174B, 174C, 174D may function as obstructing portion(s) similar to the obstructing portion 175.

Such selective positioning of the plurality of seed receivers 124 allows the spacing between seeds on the planting ground (inter-seed spacing) to be varied. The positions of the plurality of the seed receivers 124 may be represented by a sequence of symbols. It is understood that such a representation is shift-symmetric. For example, the configuration in FIG. 5A may be represented by BooBooBooBoo (equivalently, oBooBooBooBo or ooBooBooBooB), where the symbol B represents a seed receiver 124 positioned so that its receptacle 174B opens to the seed inlet 182 and the seed outlet 184 as the plurality of seed receivers 124 rotate, the symbol o represents the seed receiver 124 positioned so that the obstructing portion 175 open to the seed inlet 182 and the seed outlet 184 as the plurality of seed receivers 124 rotate, and symbols adjacent in the representation represent seed receivers that are angularly adjacent to each other.

In some embodiments, the plurality of seed receivers 124 may be positioned to achieve a configuration represented by the sequence AooAooAooAoo, where the larger receptacle 174A is suitable to release more than one seed into the furrow.

In some embodiments, the plurality of seed receivers 124 may include twenty seed receivers. In such embodiments, one configuration may be represented by the sequence AAoooAAoooAAoooAAooo. In such a configuration, two seeds are released close to each other. These groups of two seeds are spaced far apart from each other.

In various embodiments, the rejection wheel 128 may be disposed adjacent to the seed inlet 182. The rejection wheel 128 may be configured to co-rotate with the wheels 110A, 110B to push the seed away from the seed outlet 184 when the seed is not fully seated within any of the receptacles 174A, 174B, 174C, 174D.

FIG. 6A is a bottom perspective view of a furrowing shoe 132, in accordance with an embodiment.

FIG. 6B is a bottom plan view of the furrowing shoe 132.

FIG. 6C is a cross-sectional view of the furrowing shoe 132 along a plane 6C-6C in FIG. 6B, in accordance with an embodiment.

In the embodiment of FIGS. 6A-6C, the furrowing shoe 132 defines two forward walls 194A, 194B extending from the apex 164, at opposite sides of the apex 164, at the leading end 138 towards the trailing end 140. In various embodiments, the forward walls 194A, 194B may be planar or may be curved. The forward walls 194A, 194B may be angled relative to longitudinal direction so as to push soil away from the planter 100 to form a furrow. Two rear walls 190A, 190B may extend from the trailing end 140 towards the leading end 138. The rear walls 190A, 190B may be spaced apart from each other by about the furrow width 142. The rear walls 190A, 190B may be substantially parallel to each other so as to allow rectification of the furrow formed by the forward walls 194A, 194B. In various embodiments, the rear walls 190A, 190B may meet a corresponding one of the forward walls 194A, 194B. In some embodiments, the rear wall 190A may be in unitary construction with the forward wall 194A, and rear wall 190B may be in unitary construction with the forward wall 194B.

The forward walls 194A, 194B and the rear walls 190A, 190B may define a pocket 192 that is formed between opposing forward and rear walls. The pocket 192 may be suitable for receiving the base 134.

In various embodiments, the forward walls 194A, 194B and the rear walls 190A, 190B may extend vertically upwardly from a (common) bottom end 188 that is suitable for forming a bottom of the furrow.

As shown in FIGS. 6A-6C, the furrowing shoe may include a plurality of projections 146 include lower projections 146A and upper projections 146B. In various embodiments, the plurality of projections 146 may extend proximal to the leading end 138 and may also extend proximal to the trailing end 140 so as to provide support to the furrowing shoe 132 when it is shod on the base 134. In various embodiments, the plurality of projections 146 may extend from the rear walls 190A, 190B and also the forward walls 194A, 194B. In various embodiments, the plurality of projections 146 may extend from the forward walls 194A, 194B separately from the rear walls 190A, 190B, and/or may extend from the rear walls 190A, 190B separately from the forward walls 194A, 194B.

For example, some projections may extend at the trailing end 140 and may be spaced apart from projections extending at the leading end 138.

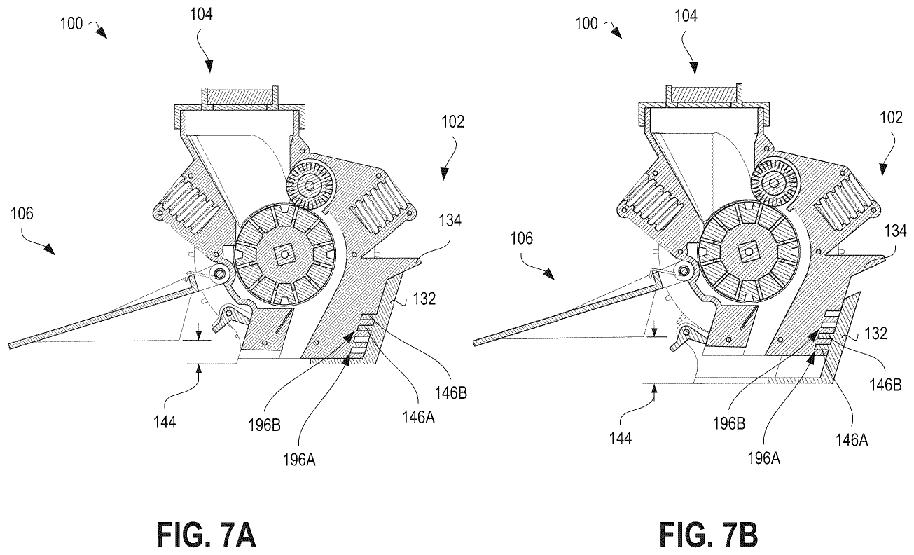

FIG. 7A is a cross-sectional view of the planter 100 along a plane defined by the line 5-5 in FIG. 1B, wherein the furrow opener 102 is in a first configuration.

FIG. 7B is a cross-sectional view of the planter 100 along a plane defined by the line 5-5 in FIG. 1B, wherein the furrow opener 102 is in a second configuration.

As shown in FIGS. 7A-7B, the plurality of projections 146 may be selectively received into lower recesses 196A of the plurality of recesses 148 or upper recesses 196B of the plurality of recesses 148 to selectively adjust the furrow height 144. For example, the first configuration, shown in FIG. 7A, may allow formation of a relatively shallow furrow, and the second configuration, shown in FIG. 7B, may allow formation of a relatively deeper furrow.

In some embodiments, four configurations corresponding to four furrow heights may be achievable. For example, the four furrow heights may be configured to correspond to industry standard planting depths or standard planting depths found on seed packages. For example, in some embodiments, when the furrowing shoe is fully seated (all of the interlocking connections being formed), the furrow height is ¼″ depth. In these embodiments, the furrowing shoe may then be adjustable to three more furrow heights, e.g. ½″, ¾″ and 1″.

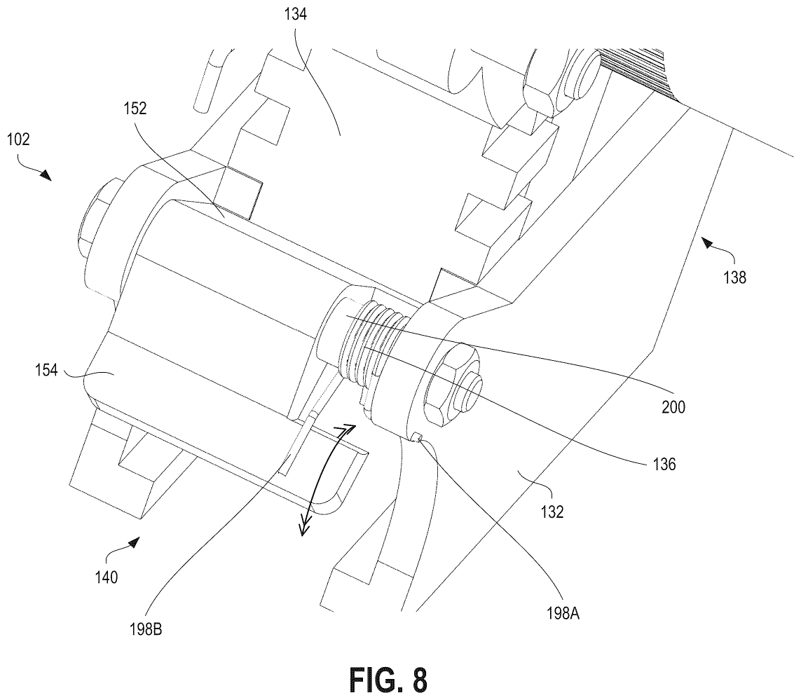

FIG. 8 is an enlarged view of a portion of the furrow opener 102, in accordance with an embodiment.

In the embodiment shown in FIG. 8, the resilient member 136 is positioned to urge the furrowing shoe 132 and the base 134 towards each to achieved interlocking engagement and to prevent disengagement.

The resilient member 136 may be attached to the furrowing shoe 132 and a paddle 152 with a predetermined natural or resting position, determined based on the positioning of the resilient member 136, relative to the furrowing shoe 132. As the furrowing shoe 132 is engaged with the base 134, the paddle 152 is displaced from its predetermined resting position, which then deforms the resilient member 136. A restoring or spring force generated by the resilient member 136 as a result of the deformation urges the resilient member 136 towards its predetermined resting position, which biasing or urging causes the paddle 152, while attached to the furrowing shoe 132, to push against a rear end of the base 134. Such pushing encourages peripheral interlocking of the furrowing shoe 132 and the base 134 at the leading end 138 by pushing the plurality of projections 146 into the plurality of recesses 148 (or vice versa). In some embodiments, the interlocking may take the form of an interference fit. In some embodiments, such an interference fit may involve sufficient friction that a user may need to push the plurality of projections 146 into the plurality of recesses 148 to achieve full interlocking. In this case, the resilient member 136 may generate a restoring force for holding the projections 146 into the plurality of recesses 148.

In various embodiments, the resilient member 136 is a torsion spring defining two legs 198A, 198B. The paddle 152 and the tab 154 are coupled to the furrowing shoe 132 via a pin 200. The paddle 152 and the tab 154 may form a unitary component. The pin 200 forms a revolute joint between the furrowing shoe 132 and the component, the resulting direction(s) of rotation being indicated by the double-chevron double-headed arrow. The pin 200 receives the torsion spring. The leg 198A is engaged with the furrowing shoe 132. For example, the leg 198A may be seated in a seat in the furrowing shoe 132. The leg 198B is engaged with the tab 154.

It is understood that the resilient member 136, instead of being attached to the furrowing shoe 132, may be attached to the base 134 such that the base 134 is pushed against the furrowing shoe 132. It is understood that the furrowing shoe 132 may be pushed into the base 134 at the leading end 138.

Peripheral interlocking and engagement of the furrowing shoe 132 and the base 134 may refer to interlocking of a periphery of the furrowing shoe 132 with a periphery of the base 134.

To disengage the furrowing shoe 132 from the base 134, the tab 154 is pressed up to rotate the paddle 152 away from the base 134. As such, the paddle 152 is frictionally disengaged from the base 134. Upon such disengagement, the furrowing shoe 132 may be movable relative to the base 134 to release the plurality of projections 146 from the plurality of recesses 148. The furrowing shoe 132 may then be vertically displaced to a desired furrow height. The plurality of projections 146 are inserted into the plurality of recesses 148 to interlock the furrowing shoe 132 with the base 134. The tab 154 is then released to cause the paddle 152 to push against the base 134 to inhibit disengagement of the furrowing shoe 132 from the base 134 by holding the plurality of projections 146 into the plurality of recesses 148 (and/or vice versa).

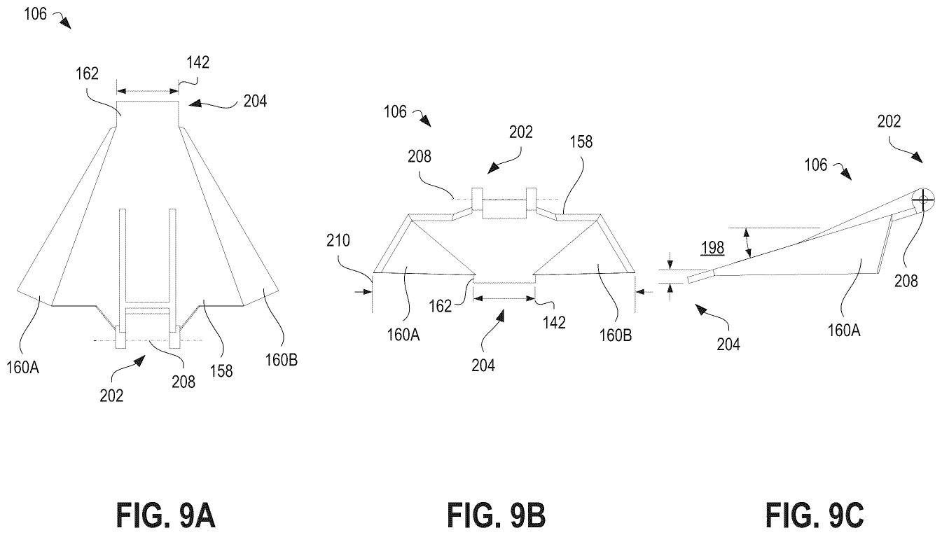

FIG. 9A is a top plan view of the furrow closer 106, in accordance with an embodiment.

FIG. 9B is a front elevation view of the furrow closer 106.

FIG. 9C is a side elevation view of the furrow closer 106.

The furrow closer 106 may define a seeding end 202 and a tamping end 204 opposite thereto. The seeder 104 may be positioned between the furrow opener 102 and the seeding end 202 of the furrow closer 106 to release the seed into the furrow. It is understood that, in some embodiments, the furrow closer 106 may be deployed without a seeder 104 at the seeding end 202. In various embodiments, the furrow closer 106 may be positioned higher than a lower end of the furrow opener 102.

The end of the furrow closer 106 at the seeding end 202 may be set at or slightly above the outer edge of the wheels 110A, 110B, which may be positioned at ground level. The furrow closer 106 may thereby be allowed to drag along the ground without pushing soil up at its leading edge. The furrow height 144 may extend from the seeding end 202 of the furrow closer 106 to the bottom of the furrowing shoe 132.

The central wall 158 extends obliquely, over the furrow, towards the planting ground from the seeding end 202 to the tamping end 204 proximal to the planting ground relative to the seeding end 202. It is found to be particularly advantageous for the central wall 158 to extend obliquely towards the planting ground at an angle 198 between 15 and 20 degrees relative to the planting ground.

The central wall 158 laterally tapers to the width 142 of the furrow from the seeding end 202 to the tamping end 204.

The central wall 158 may be disposed behind and laterally in-between the two wheels 110A, 110B.

The sidewalls 160A, 160B are positioned at laterally opposite ends of the central wall 158 between the seeding end 202 and the tamping end 204. The furrow height 144 may be defined between the sidewalls 160A, 160B at the seeding end 202 and the bottom of the furrowing shoe 132.

The furrow opener 102 serves to dig up soil to form the furrow. Such digging up of the soil generates piles of soil on either side of the furrow. For closing of the furrow, such piles need to be pushed towards the furrow (laterally, lateral to the longitudinal direction), then pushed into the furrow, and then tamped down to close the furrow.

As mentioned previously, the diameter of the wheels 110A, 110B may be configured to achieve a desired inter-seed spacing under geometric constraints imposed by the size of the seed receivers 124 and the size of the rotors 166A, 166B. Similarly, the diameter of the rotors 166A, 166B may be configured to be sufficiently small to form the suitable spaces 167A, 167B between the wheels 110A, 110B and the respective rotors 166A, 166B under geometric constraints imposed by the size of the seed receivers 124.

In various embodiments, inclined surfaces 169A, 169B are formed between respective wheels 110A, 110B and the rotors 166A, 166B. Advantageously, such a configuration aids soil flow by encouraging the soil displaced by digging of the furrow to slide up into the spaces 167A, 167B. The angle inclination is configured to improve soil flow by encouraging soil to flow more easily under the seeder in a compact space.

As a result of the inclined surfaces 169A, 169B the soil displaced from the planting ground due to digging of the furrow forms elongated piles shaped by the inclined surfaces 169A, 169B, e.g. with sides that are inclined based on the inclined surfaces 169A, 169B.

The width 210 of the furrow closer 106 may be sufficiently large to allow the furrow closer 106 at the seeding end 202 to span the furrow. In various embodiments, the furrow closer 106 may be sufficiently wide at the seeding end 202 to span the furrow and accumulated (piled) soil adjacent to the furrow. It was found to be particularly advantageous that the width 210 be sufficiently large to span the gap 212 (shown in FIG. 1B) between the wheels 110A, 110B. In some embodiments, the width 210 may be larger than the gap 212 but smaller than the width of the planter 100 or the outer ends of the wheels 110A, 110B.

The sidewalls 160A, 160B extend at least partially lateral to the central wall 158 towards the planting ground so as to push soil (laterally) towards the furrow underneath the central wall 158 to allow the central wall 158 to urge the soil into the furrow. The oblique orientation of the central wall 158 serves to push the soil down to achieve closing of the furrow as the sidewalls 160A, 160B direct soil towards underneath the central wall 158.

In some embodiments, the sidewalls 160A, 160B are configured based on the inclined surfaces 169A, 169B such that soil piles formed by the inclined surfaces 169A, 169B are complementary to sidewalls 160A, 160B, and/or the spaces under the sidewalls 160A, 160B, i.e. between the sidewalls 160A, 160B and the planting ground. Advantageously, a clean furrow opening and closing may thereby be achieved. For example, the performance of such a furrow may at least partially be determined based on a ratio between the amount of soil replaced back into the planting ground to close the furrow and the amount of soil initially displaced out of the planting ground to open the furrow. For example, the nearer such a ratio is to one, the cleaner the opening and/or closing of the furrow may be deemed to be. For example, the performance of furrow closing may at least partially be determined based on the height of the planting ground above a closed furrow relative to the height of the planting ground around the closed furrow. Clean furrow opening and closing may be particularly important for planting in small gardens, where plant spacing may be particularly small and plant rows may be relatively close to one another.

In various embodiments, outer edges of the sidewalls 160A, 160B proximal to the seeding end 202 (e.g. see edge 214 in FIG. 1B) may be dimensioned based on axially inner edges of the projections 111 (e.g. see edge 215 in FIG. 1B). For example, outer edges of the sidewalls 160A, 160B may be angled complementarily to the axially inner edges of the projections 111. The projections 111 may extend radially outwardly more on one side of the axially inner edges than an opposite side thereof to encourage soil to move towards and underneath the sidewalls 160A, 160B. In various embodiments, the width 210 of the furrow closer 106 may be defined by laterally outer ends of the sidewalls 160A, 160B at the seeding end 202. The width 210 may be configured so that the sidewalls 160A, 160B do not extend beyond the axially inner edges of the projections 111.

The tamper 162, positioned at the tamping end 204, may then tamp down on the planting ground over the filled in furrow. In various embodiments, the tamper 162 may be parallel to the central wall 158. In various embodiments, the tamper 162 is substantially rectangular and extends laterally at least the width of the of the furrow.

In some embodiments, the tamper 162 may be a roller-type tamper.

The furrow closer 106 may be resiliently rotatable about a lateral axis 208 to cause positioning of the tamper 162 of the furrow closer 106 based on the planting ground. A resilient member such as the spring 186, which may be a torsion spring configure to resist rotational repositioning of the furrow closer 106 about the lateral axis 208, may urge the furrow closer 106 on to the planting ground to facilitate lateral pushing of the soil towards the furrow, pushing of soil into the furrow, and tamping of the planting ground over the filled-in furrow.

In some embodiments, the central wall 158, the sidewall 160A, and the sidewall 160B may be planar walls that are angled relative to each other.

In various embodiments, as the wheels 110A, 110B roll forward, they may advantageously flatten the soil in a consistent and repeatable manner to create a desirable surface for the furrow closer 106 to slide over, e.g. to facilitate gliding of the sidewalls 160A, 160B over the ground, to cover the furrow in a precision manner.

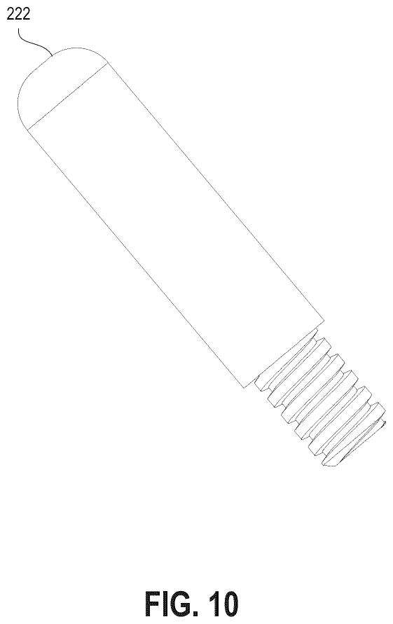

FIG. 10 is a side elevation view of a handle 222, in accordance with an embodiment.

The handle 222 may be fitted on to the planter 100. In some embodiments, the handle 222 may be friction fit or threadable engaged with the planter 100. In the embodiment of FIG. 1D, the planter 100 include two ports 220A, 220B for receiving the handle 222. The port 220A may be a forward port and the port 220B may be a rear port. Advantageously, the handle 222 may be selectively (threadably and/or frictionally) engaged with one of the ports 220A, 220B. An operator may engage the handle 222 with one of the ports 220A, 220B depends on their preference. It is found to be particularly advantageous to allow the planter 100 to be rolled back on the furrow it forms without being lifted and changed in direction.

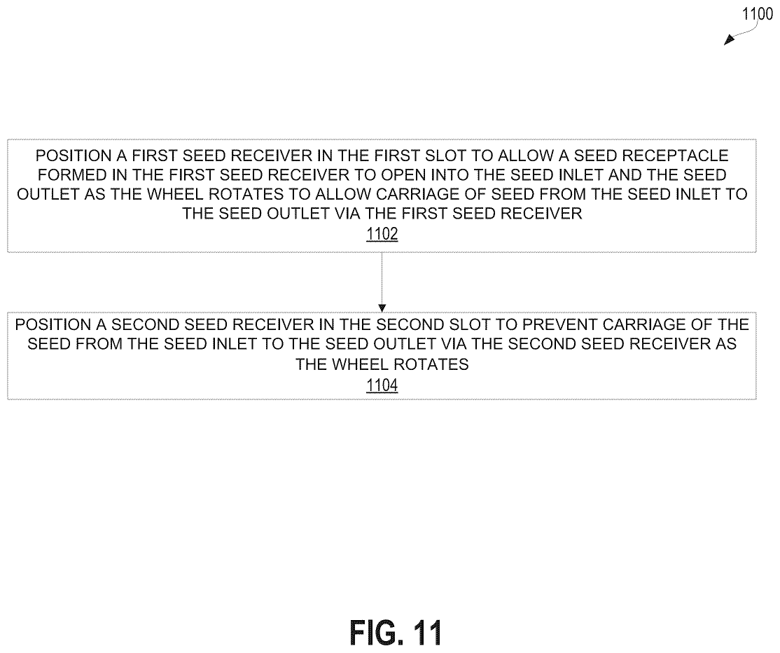

FIG. 11 is an exemplary flowchart of a method 1100 of configuring a planter to selectively define an inter-seed spacing on a planting ground.

The planter may define a wheel rotatable to draw the planter along the planting ground. The planter may also define first and second slots that are angularly spaced apart from each other. The first and second slots may be configured to rotate around a slot axis between a seed inlet and a seed outlet in response to rotation of the wheel.

Step 1102 of the method 1100 includes positioning a first seed receiver in the first slot to allow a seed receptacle formed in the first seed receiver to open into the seed inlet and the seed outlet as the wheel rotates to allow carriage of seed from the seed inlet to the seed outlet via the first seed receiver.

Step 1104 of the method 1100 includes positioning a second seed receiver in the second slot to prevent carriage of the seed from the seed inlet to the seed outlet via the second seed receiver as the wheel rotates.

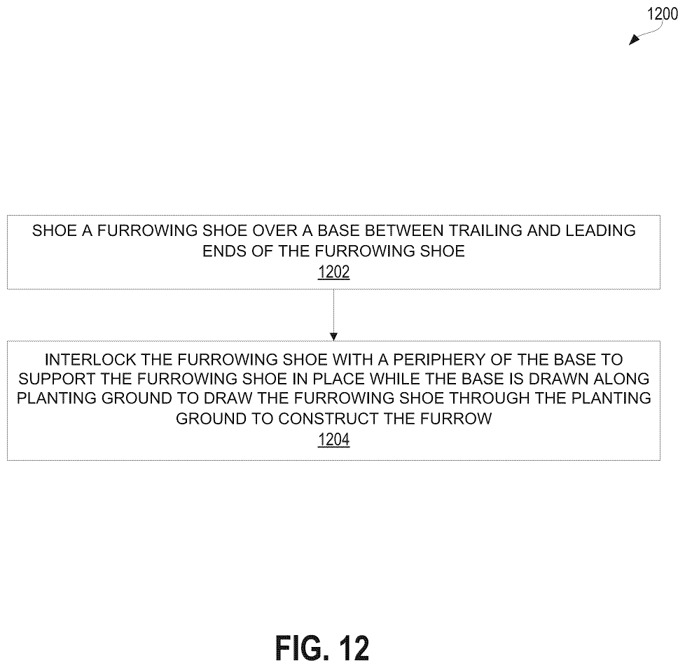

FIG. 12 is an exemplary flowchart of a method 1200 of assembling a device for constructing a furrow on planting ground.

Step 1202 of the method 1200 includes shoeing a furrowing shoe over a base between trailing and leading ends of the furrowing shoe.

Step 1204 of the method 1200 includes interlocking the furrowing shoe with a periphery of the base to support the furrowing shoe in place while the base is drawn along planting ground to draw the furrowing shoe through the planting ground to construct the furrow.

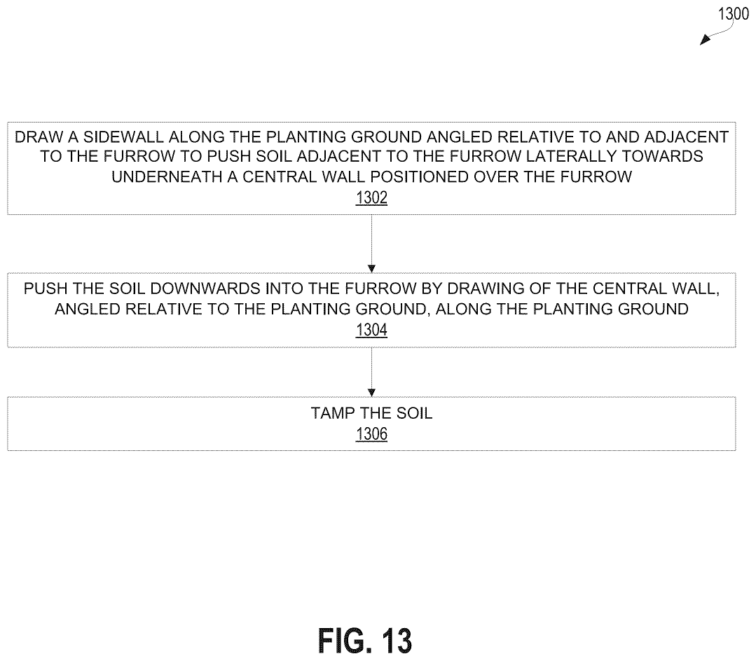

FIG. 13 is an exemplary flowchart of a method 1300 of closing a furrow formed in a planting ground.

Step 1302 of the method 1300 includes drawing a sidewall along the planting ground angled relative to and adjacent to the furrow to push soil adjacent to the furrow laterally towards underneath a central wall positioned over the furrow.

Step 1304 of the method 1300 includes pushing the soil downwards into the furrow by drawing of the central wall, angled relative to the planting ground, along the planting ground.

Step 1306 of the method 1300 includes, after pushing the soil downwards using the central wall, tamping the soil.

As can be understood, the examples described above and illustrated are intended to be exemplary only.

The embodiments described in this document provide non-limiting examples of possible implementations of the present technology. Upon review of the present disclosure, a person of ordinary skill in the art will recognize that changes may be made to the embodiments described herein without departing from the scope of the present technology. For example, the planter may comprise a single wheel or three wheels, the planter may include one or more of the furrow opener, seeder, or closer, and the seed hopper may be replaced with a direct seed feed system. Yet further modifications could be implemented by a person of ordinary skill in the art in view of the present disclosure, which modifications would be within the scope of the present technology.

What is claimed is:

1. A device for constructing a furrow on planting ground, comprising:
a furrowing shoe for constructing the furrow, the furrowing shoe tapering to a leading end from a trailing end defining a furrow width;
a base that is suitable for being drawn along the planting ground and that is tapered based on the furrowing shoe so as to be complementarily shod by the furrowing shoe between the leading and trailing ends, the base and the furrowing shoe being selectively peripherally interlockable at first or second furrowing positions of the furrowing shoe so as to support the furrowing shoe vertically high at the first furrowing position or vertically low at the second furrowing position to allow the trailing end to modulate a furrow height when the furrowing shoe is received on the base; and
a resilient member that is positioned to urge the furrowing shoe and the base towards each other to inhibit peripheral disengagement of the furrowing shoe and the base from each other.

2. The device of claim 1, wherein the base and the furrowing shoe comprise a plurality of projections extending between the base and the furrowing shoe, each of the plurality of projections being suitable to be received in at least one recess to modulate the furrow height and to facilitate interlocking of the base and the furrowing shoe.

3. The device of claim 1, wherein the furrowing shoe comprises a plurality of projections extending from an inner surface of the furrowing shoe and being vertically spaced apart from each other, and the base comprises a plurality of recesses extending along a periphery of the base and being vertically spaced apart from each other, the plurality of projections and the plurality of recesses configured to interlock with each other to position the furrowing shoe relative to the base to modulate the furrow height.

4. The device of claim 3, wherein the leading end forms an apex for pushing soil from opposite sides of the apex away from the furrowing shoe to construct the furrow, the plurality of projections extending from the inner surface of the furrowing shoe at the opposite sides, the plurality of recesses extending along the periphery of the base at the opposite sides.

5. The device of claim 1, wherein the resilient member is a torsional spring coupled to the furrowing shoe proximal to the trailing end of the furrowing shoe, relative to the leading end, so as to rotationally urge a paddle against the base to push the base and the leading end of the furrowing shoe towards each other to inhibit peripheral disengagement of the furrowing shoe and the base from each other, the furrowing shoe being releasable from the base via rotation of the paddle away from the base.

6. A planter for planting seed in a planting ground, comprising:
a furrow opener configured to construct a furrow in the planting ground as the planter is drawn along the planting ground, including
a furrowing shoe that tapers to a leading end from a trailing end to form the furrow, the trailing end defining a furrow width,
a base that is suitable for being drawn along the planting ground and that is tapered based on the furrowing shoe so as to be complementarily shod by the furrowing shoe between the leading and trailing ends, the base and the furrowing shoe being selectively peripherally interlockable at first or second furrowing positions of the furrowing shoe so as to support the furrowing shoe vertically higher, relative to the base, at the first furrowing position or vertically lower, relative to the base, at the second furrowing position to allow the trailing end to define a furrow height when the furrowing shoe is received on the base, and
a resilient member that is positioned to urge the furrowing shoe and the base towards each other to inhibit peripheral disengagement of the furrowing shoe and the base from each other;
a furrow closer to close the furrow; and
a seeder positioned between the furrow opener and the furrow closer to release the seed into the furrow.

7. The planter of claim 6, wherein the base and the furrowing shoe comprise a plurality of projections extending between the base and the furrowing shoe, each of the plurality of projections being suitable to be received in at least one recess to modulate the furrow height and to facilitate interlocking of the base and the furrowing shoe.

8. The planter of claim 6, wherein the furrowing shoe comprises a plurality of projections extending from an inner surface of the furrowing shoe and being vertically spaced apart from each other, and the base comprises a plurality of recesses extending along a periphery of the base and being vertically spaced apart from each other, the plurality of projections and the plurality of recesses configured to interlock with each other to position the furrowing shoe relative to the base to modulate the furrow height.

9. The planter of claim 8, wherein the leading end forms an apex for pushing soil from opposite sides of the apex away from the furrowing shoe to construct the furrow, the plurality of projections extending from the inner surface of the furrowing shoe at the opposite sides, the plurality of recesses extending along the periphery of the base at the opposite sides.

10. The planter of claim 6, wherein the resilient member is a torsional spring coupled to the furrowing shoe proximal to the trailing end of the furrowing shoe, relative to the leading end, so as to rotationally urge a paddle against the base to push the base towards the leading end of the furrowing shoe to inhibit peripheral disengagement of the furrowing shoe and the base from each other, the furrowing shoe being releasable from the base via rotation of the paddle away from the base.

11. The planter of claim 6, wherein the furrow closer includes:
a central wall extending obliquely towards the planting ground from a seeding end to a tamping end proximal to the planting ground relative to the seeding end, the central wall laterally tapering to the furrow width from the seeding end to the tamping end,
first and second sidewalls positioned at laterally opposite ends of the central wall between the seeding and tamping ends and extending at least partially lateral to the central wall towards the planting ground so as to push soil towards the furrow underneath the central wall to allow the central wall to urge the soil into the furrow to close the furrow, and
a tamper positioned at the tamping end for tamping down on the planting ground; and

12. The planter of claim 11, wherein the central wall extends obliquely towards the planting ground at between 15 and 20 degrees relative to the planting ground, and the central wall, the first sidewall, and the second sidewall are planar walls that are angled relative to each other.

13. The planter of claim 11, wherein the tamper is substantially rectangular and extends laterally at least the furrow width.

14. The planter of claim 11, further comprising:
a first wheel positioned at a first lateral end of the planter; and
a second wheel positioned at a second lateral end of the planter, the central wall disposed behind and laterally in-between the first wheel and the second wheel.

15. The planter of claim 11, wherein the furrow closer is positioned higher than a lower end of the furrow opener.

16. A method of assembling a device for constructing a furrow on planting ground, comprising:
shoeing a furrowing shoe over a base between trailing and leading ends of the furrowing shoe; and
interlocking the furrowing shoe with a periphery of the base to support the furrowing shoe in place while the base is drawn along planting ground to draw the furrowing shoe through the planting ground to construct the furrow.

17. The method of claim 16, wherein the base and the furrowing shoe comprise a plurality of projections extending between the base and the furrowing shoe, each of the plurality of projections being suitable to be received in at least one recess to modulate a furrow height and to facilitate interlocking of the base and the furrowing shoe.

18. The method of claim 16, wherein the furrowing shoe comprises a plurality of projections extending from an inner surface of the furrowing shoe and being vertically spaced apart from each other, and the base comprises a plurality of recesses extending along a periphery of the base and being vertically spaced apart from each other, the plurality of projections and the plurality of recesses configured to interlock with each other to position the furrowing shoe relative to the base to modulate a furrow height.

19. The method of claim 18, wherein the leading end forms an apex for pushing soil from opposite sides of the apex away from the furrowing shoe to construct the furrow, the plurality of projections extending from the inner surface of the furrowing shoe at the opposite sides, the plurality of recesses extending along the periphery of the base at the opposite sides.

20. The method of claim 16, further comprising:
urging the furrowing shoe and the base towards each other using a resilient member to inhibit peripheral disengagement of the furrowing shoe and the base from each other.

21. The method of claim 20, wherein the resilient member is a torsional spring coupled to the furrowing shoe proximal to the trailing end of the furrowing shoe, relative to the leading end, so as to rotationally urge a paddle against the base to push the base and the leading end of the furrowing shoe towards each other to inhibit peripheral disengagement of the furrowing shoe and the base from each other, the furrowing shoe being releasable from the base via rotation of the paddle away from the base.
